(19) United States
(12) Patent Application Publication
(10) Pub. No.: US 2005/0287813 A1
(43) Pub. Date: Dec. 29, 2005

(54) Manufacturing method of semiconductor device and semiconductor manufacturing apparatus

(76) Inventors: Takeshi Kikawa, Kodaira (JP); Hiroyuki Uchiyama, Musashimurayama (JP); Takafumi Taniguchi, Tokyo (JP)

Correspondence Address: REED SMITH LLP, Suite 1400, 3110 Fairview Park Drive, Falls Church, VA, 22042, US

(21) Appl. No.: 10/929,778

(22) Filed: Aug. 31, 2004

(30) Foreign Application Priority Data
Jun. 29, 2004 (JP) 2004-190888

(51) Int. Cl. G03C 5/00

(52) U.S. Cl. 438/710

(57) ABSTRACT

An apparatus for decreasing plasma-induced damage caused by exposure to plasma is provided in an apparatus for manufacturing semiconductor devices using plasma. An apparatus is used for irradiating the semiconductor surface with as least one of X-rays and UV-rays in a vacuum or in an inert atmosphere after plasma processing.

### CLAIM OF PRIORITY

The present application claims priority from Japanese Application JP 2004-190888 filed on Jun. 29, 2004, the content of which is hereby incorporated by reference into this application.

### BACKGROUND OF THE INVENTION

1. Field of the Invention

The present invention relates to a manufacturing apparatus for semiconductor devices and a manufacturing apparatus for semiconductor lasers and, more in particular, it relates to a manufacturing apparatus for semiconductor devices or semiconductor lasers capable of removing fabrication damages, for example, to wafers if any in a plasma process of semiconductor device manufacturing steps thereby decreasing undesired effects on devices and improving the yield and the reliability of products.

2. Description of the Related Art

The manufacturing steps for semiconductor devices include those steps, for example, a plasma process such as plasma etching and plasma CVD that damage wafers during fabrication and tend to cause destruction and degradation of devices.

For example, referring to the outline for a method of manufacturing a high electron mobility transistor (HEMT) having a recessed structure, an AlGaAs buffer layer, an InGaAs channel layer, a GaAs cap layer and an SiO₂ film are formed successively on a semi-insulative GaAs substrate. Then, the SiO₂ film is bored to form a burying recess. A gate metal is deposited to form a T-type gate of a predetermined shape and a photoresist is formed into a wide recess pattern. Then, a gate electrode can be formed by etching the GaAs cap layer and the InGaAs channel layer in the shape of a wide recess pattern. This manufacturing method is disclosed by Japanese Patent Laid-open No. H11-150125.

In this case, a plasma process is utilized for the deposition or etching of the SiO₂ film. That is, a plasma enhanced chemical vapor deposition process (p-CVD) using, for example, an SiH₄ gas, an N₂O gas or the like can be used for the deposition of the SiO₂ film, a reactive ion etching method (RIE) using, for example, a fluoric gas such as CF₄ can be used for the etching of the SiO₂ film, and a dry etching method using a gas containing halogen atoms such as fluorine atoms or chlorine atoms can be utilized for the etching of the semiconductor layer.

In the etching process of a metal film, an insulating film or a semiconductor by utilizing the plasma, and a thin film forming process by a sputtering method or a CVD method utilizing plasma, a phenomenon in which ions or radicals are implanted into a substrate is caused due to the potential difference between the plasmas and the specimen. Implanted ions or radicals lower the carrier density by the inactivation of carriers, increase of resistance by diffusion of impurities, formation of non-emissive recombination center, etc. to deteriorate electrical characteristics or lower the reliability of the device.

### SUMMARY OF THE INVENTION

An object of the present invention is to provide a manufacturing apparatus for a semiconductor device with less deterioration of characteristics and having good reliability by the recovery from undesired deterioration of characteristics, that is, plasma damages caused in the process using plasmas.

The subject described above can be solved by applying a surface treatment of applying at least one of X-rays and UV-rays to plasma-exposed surface during or after the process utilizing the plasma.

Plasma-induced damage is caused by the intrusion of impurity atoms such as oxygen and fluorine into semiconductor crystals. By the bonding of the impurity atoms with dopants, the dopants are compensated to lower the carrier density and deteriorate the device characteristics. In this case, the impurity ions are generally ionized into negative ions and have ionic bonds. It has been generally known that photoelectrons are emitted when X-rays and UV-rays are applied to a substance. The present inventors have found that when X-rays and UV-rays are applied to the ionized impurity atoms to emit photoelectrons, the impurity atoms become electrically neutral, are dissociated from the bonding with the dopants, suspended in the inter-lattice space, and detached from the crystals when they reach the crystal surface.

More specifically, the object described above can be achieved in accordance with an aspect of the present invention by a method of manufacturing a semiconductor device of etching a work formed on a semiconductor substrate or depositing a metal film or an insulating film on a semiconductor substrate by using plasma, which method comprises conducting etching or deposition by using the plasmas and then irradiating the semiconductor substrate at least one of X-rays and UV-rays in a vacuum or in an inert gas atmosphere.

Further, the object of the invention can be attained by a semiconductor manufacturing apparatus according to another aspect of the invention comprising a processing chamber for etching a work formed on a semiconductor substrate or forming a film on a semiconductor substrate, and a surface treating chamber of irradiating the semiconductor substrate with at least one of X-rays and UV-rays in a vacuum or in an inert gas atmosphere, in which the semiconductor substrate is transported from the processing chamber to the surface treatment chamber and the irradiation is controlled in the surface treatment chamber.

Further, the object of the invention can be attained by a semiconductor manufacturing apparatus according to another aspect of the invention comprising a holding section for holding a semiconductor substrate, and an irradiation section for irradiation of at least one of X-rays and UV-rays, in which the inside of the holding section and the inside of the irradiation section are kept in a vacuum or in an inert gas atmosphere, and in which a semiconductor substrate after etching of a work formed on the semiconductor substrate or after deposition of a metal film or an insulating film on the semiconductor substrate is held in the holding section and the semiconductor substrate is irradiated with at least one of X-rays and UV-rays from the irradiation section.

The invention can remove impurity elements intruded into the crystals caused by the plasma process by irradiation of X-rays and irradiation of UV-rays thereby suppressing lowering of the carrier density and can contribute to improvement of the quality and productivity of devices.

### BRIEF DESCRIPTION OF THE DRAWINGS

Preferred embodiments of the present invention will be described in details based on the drawings, wherein:

FIG. 1 is a view showing an example of a multi-chamber type apparatus for manufacturing semiconductor devices to which the present invention is applied;

FIG. 2 is a view showing an example of a manufacturing apparatus for semiconductor devices in which a surface treatment device of the invention is incorporated to a single process type apparatus;

FIG. 3 is a view showing an example of a multi-chamber type apparatus for manufacturing semiconductor devices to which the invention is applied;

FIG. 4 is a view showing an example of a specimen storage housing to which the invention is applied;

FIG. 5 is a view showing an X-ray source provided with a waveguide tube; and

FIG. 6 is a view showing another example of a specimen storage housing to which the invention is applied.

### DESCRIPTION OF THE PREFERRED EMBODIMENT

Preferred embodiments of the present invention are to be described with reference to the drawings.

### Embodiment 1

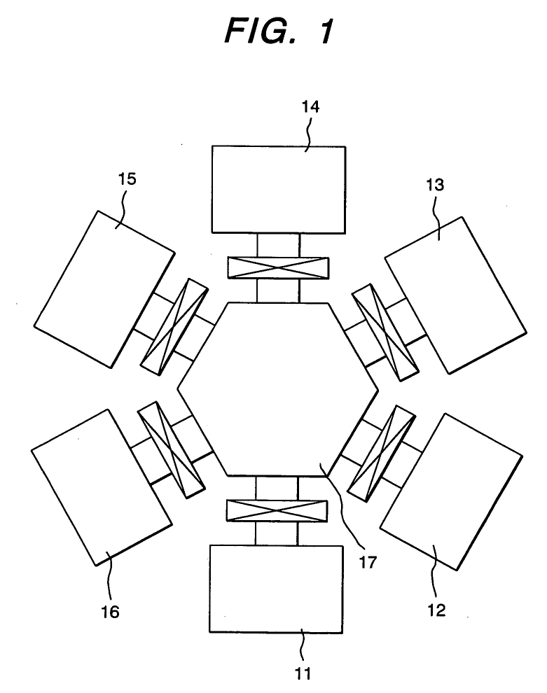

FIG. 1 is a schematic view. In a first embodiment, the invention is applied to a multi-chamber type processing apparatus comprising a load lock chamber 11 for loading and unloading specimens, and a plurality of processing chambers 12 to 16 for conducting processing such as etching and deposition of insulating films in which each of the processing chambers and the load lock chamber are connected by way of a transport chamber 17. Each of the processing chambers and the load lock chamber are partitioned from the transport chamber by a gate valve. The surface treatment chamber 16 in the figure comprises an X-ray source and a UV-ray source and can irradiate specimens in vacuum or in an inert gas atmosphere at low pressure, for example, in a nitrogen atmosphere at 0.1 Pa, with X-rays and UV-rays simultaneously or individually.

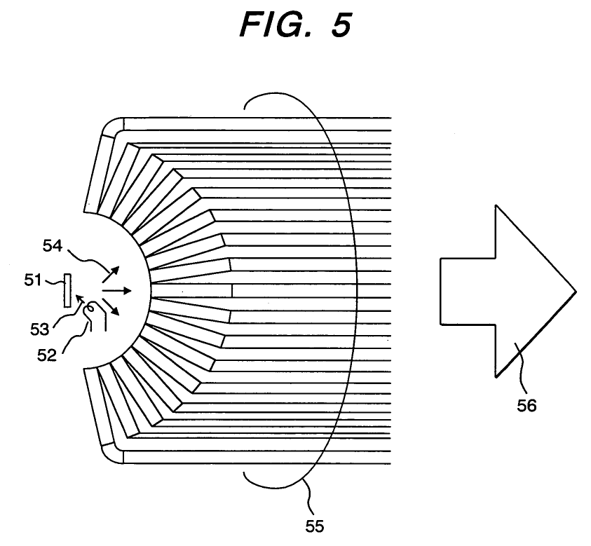

For the X-ray source, those X-ray targets used generally for the application use of X-ray diffraction, X-ray photoelectron spectroscopy, X-ray fluorescence analysis and X-ray illumination such as Mg, Al, Fe, Cr, Cu, Mo, W and Y can be utilized. A rotary target may also be used in order to increase the X-ray power. X-rays emitted from the X-ray source may be directly applied to specimens. Alternatively, as shown in FIG. 5, an inlet for an X-ray waveguide tube 51 may be disposed so as to cover the X-ray source in a hemispherical shape to guide X-rays as far as the specimen surface. This can improve the usability of X-rays and X-rays can be applied only to damaged regions intended to be applied by X-rays by gathering the bundle of waveguide tubes. For the UV-ray source, for example, a deuterium lamp, mercury lamp, excimer lamp, He lamp, Ne lamp or the like may be used. The wavelength of X-rays is 10 keV or less, preferably, 1 to 2 keV. For the wavelength of the UV-rays, an arbitrary energy in a rage of 4 eV or more and 10 eV or less can be utilized. However, since the intrusion depth of the UV-rays at an wavelength of 100 eV or less is 100 nm or less, while this is effective for the removal of damages close to the surface, irradiation of X-rays of a shorter wavelength at an energy of about 1 to 2 keV should be used for the removal of flaws in a deeper region.

In this apparatus, an SiO₂ film is etched by using a CF₄ gas in the insulating film etching chamber 12 for instance and then the specimens are transported in a vacuum to the surface treatment chamber 16 and X-rays can be applied thereto. This can dissociate and remove fluorine atoms intruded in the crystals upon etching of the SiO₂ film. While the SiO₂ film is shown as an example of the insulating film, it will be apparent that other insulating films, for example, Al₂O₃, AlN, TiO₂, SiN films, etc. can also be treated quite in the same manner.

In the same manner, the GaAs surface is etched by using a hydrogen chloride gas in the semiconductor etching chamber 13 and then is irradiated with UV-rays in the surface treatment chamber 16, whereby chlorine atoms intruding in the crystals can be removed. While GaAs is shown as an example of the semiconductor, other semiconductors, for example, Si, SiC, SiGe, AlGaAs, InGaAsP, InGaP, InAlP, InGaAlAsP, InGaAs, InAlAs can also be treated quite in the same manner.

When the insulating film is formed in the insulating film deposition chamber 14, oxygen contained in the film deposition gas or fluorine remaining in the residual atmosphere may sometimes intrude into crystals. In this case, after film deposition, intruded impurity atoms such as oxygen or fluorine are irradiated with X-rays in the surface treatment chamber 16 for removal.

In a case of ashing resists or carbides left on the surface after etching in the ashing chamber 15 by using an oxygen gas and removing them, oxygen is sometimes implanted into crystals. Further, in a case of ashing and removing the insulating film by using a CF₄ gas, fluorine may sometimes intrude into the crystals. Also in these cases, after the ashing processing, intruded impurity atoms can be irradiated with X-rays or UV-rays for removal in the surface treatment chamber 16.

Although not illustrated, also after the process of etching metal films or electroconductive films comprising, for example, Al, Ti, Mo, W, WSi and WSiN by using C₂F₆, fluorine atoms intruded into the crystals can be dissociated and removed by irradiation of X-rays in the same manner as described above. While CH₄, HCl or C₂F₆ is used as the gas, similar effects can also be obtained in a case of using other fluorine-containing gases or halogen element-containing gases, for example, CHF₃, SF₆, HBr or HI.

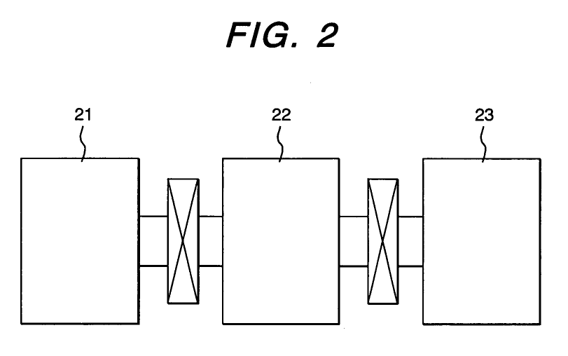

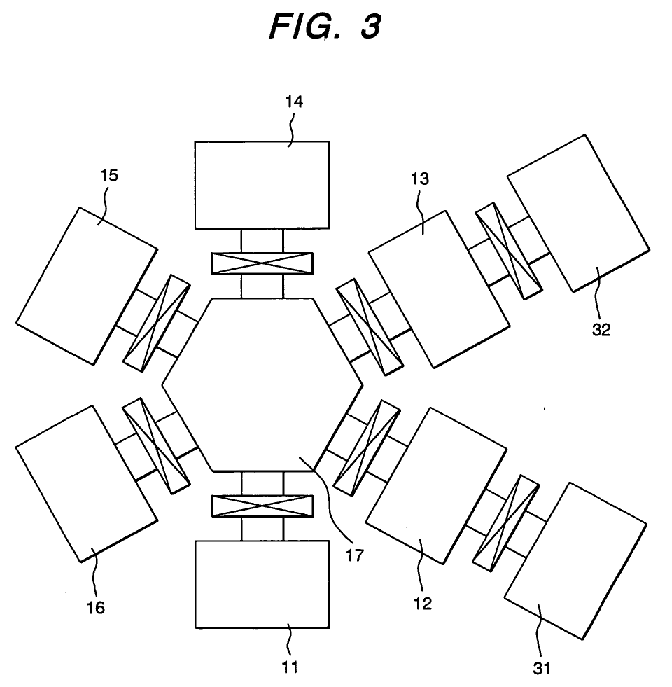

This embodiment shows a case of applying the invention to a multi-chamber type processing apparatus having a plurality of functions, but it will be apparent that same effects can also be obtained by applying the invention to a single function type apparatus such as an etching apparatus or film deposition apparatus as shown in FIG. 2. Further, while the surface treatment chamber according to the invention is provided in one of the multi-chambers in this embodiment, a surface treatment chamber 31 may be appended to each of the processing chambers and X-ray or UV-ray may be applied therein, for example, as shown in FIG. 3. In a case of attaching a window to any of the surface treatment chambers for monitoring the inside of the apparatus from the outside, it is necessary to take care so as not to leak X-rays and UV-rays by using lead glass or the like and covering the inside and the outside of the apparatus with a shielding body for radiation rays such as X-rays using lead or the like.

### Embodiment 2

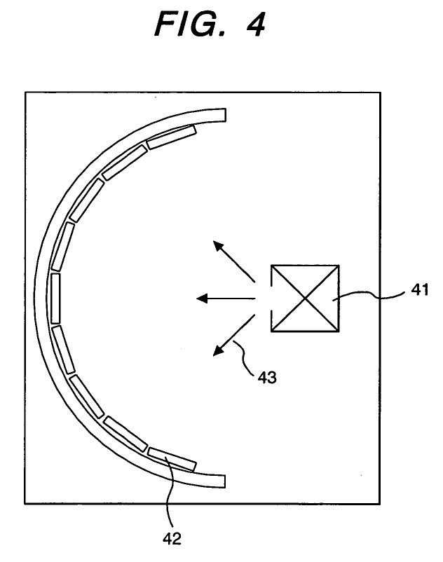

FIG. 4 shows a second embodiment of applying the invention to a wafer storage housing. For example, after the etching treatment or the insulating film forming treatment, in some cases, the succeeding steps cannot be applied directly by some or other reasons and so wafers are stored as they are for a while. In such a case, when an X-rays source or a UV-ray source 41 are provided in the storage housing and X-rays or UV-rays are applied to the specimens to conduct the treatment of removing process damages, devices with no degradation of characteristics can be obtained.

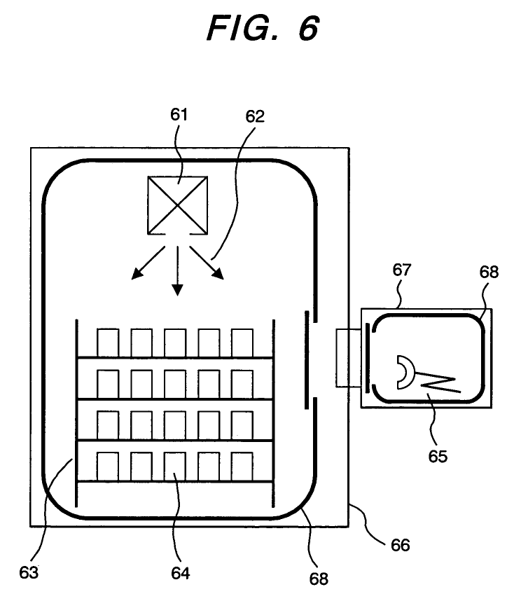

FIG. 4 shows an example of irradiating wafers arranged one by one in the storage housing. Wafers may also be housed while being contained in a specimen case in the storage housing as shown in FIG. 6. A door for the storage housing may be opened and closed to directly transport the wafers or specimen cases in the storage housing, or they may be transported by a manipulator by providing an access port as shown in FIG. 6. Apparently, it will be preferred to provide a safety device so as to stop the irradiation of X-rays and UV-rays upon loading and unloading the specimens.

Explanations for references in the drawings of the application are as below.

11 . . . load lock chamber, 12 . . . insulating film etching chamber, 13 . . . semiconductor etching chamber, 14 . . . insulating film deposition chamber, 15 . . . ashing chamber, 16 . . . surface treatment chamber for irradiation of X-rays or UV-rays 17 . . . transport chamber, 21 . . . load lock chamber, 22 . . . processing chamber for conducting processing such as etching or film deposition, 23 . . . surface treatment chamber for irradiation of X-rays or UV-rays, 31 . . . surface treatment chamber attached to the insulating film etching chamber for irradiation of X-rays and UV-rays, 32 . . . surface treatment chamber attached to the semiconductor film etching chamber for irradiation of X-rays or UV-rays, 41, 43, 61, 62 . . . X-ray source or a UV-ray source, or radiation source comprising an X-ray source and a UV-ray source, 42 . . . specimen, 51 . . . X-ray target, 52 . . . electron beam source, 53 . . . high-speed electron beam, 54 . . . X-rays emitted from X-ray target, 55 . . . X-ray waveguide tube bundle, 56 . . . X-ray arranged in parallel or bundled, 63 . . . specimen case storing shelf, 64 . . . specimen case, 65 . . . specimen case transporting manipulator, 66 . . . specimen storage housing main body, 67 . . . specimen access port, 68 . . . X-ray shielding body.

1. A method of manufacturing a semiconductor device of etching a work formed on a semiconductor substrate or depositing a metal film or an insulating film on a semiconductor substrate by using plasma, comprising:
conducting etching or deposition by using the plasma; and
irradiating the semiconductor substrate with at least one of X-rays and UV-rays in a vacuum or in an inert gas atmosphere.

2. A manufacturing method of semiconductor devices according to claim 1, wherein the work is an insulating film.

3. A manufacturing method of semiconductor devices according to claim 1, wherein the work is a semiconductor film.

4. A manufacturing method of a semiconductor device according to claim 1, wherein the work is a metal film or an electroconductive film.

5. A manufacturing method of semiconductor devices according to claim 1, further comprising preparing an ashing apparatus using plasma.

6. A manufacturing method of semiconductor devices according to claim 1, wherein the X-rays or the UV-rays have an energy in a range from 4 eV or more and 10 keV or less.

7. A manufacturing method of semiconductor devices according to claim 1, wherein the X-rays have an energy in a range from 1 to 2 keV.

8. A manufacturing method of semiconductor devices according to claim 1, wherein the UV-rays have an energy in a range from 4 to 10 eV.

9. An apparatus for manufacturing semiconductor devices, comprising:
a processing chamber for etching a work formed on a semiconductor substrate or depositing a film on a semiconductor substrate;
a surface treatment chamber used for irradiating the semiconductor substrate with at least one of X-rays and UV-rays in a vacuum or in an inert gas atmosphere; and
means for transporting the semiconductor substrate from the processing chamber to the surface treatment chamber and controlling the irradiation in the surface treatment chamber.

10. A semiconductor manufacturing apparatus according to claim 9, wherein the work is an insulating film.

11. A semiconductor manufacturing apparatus according to claim 9, wherein the work is a semiconductor.

12. A semiconductor manufacturing apparatus according to claim 9, wherein the work is a metal film or an electric conductive film.

13. A semiconductor manufacturing apparatus according to claim 9, further comprising an ashing apparatus using plasma.

14. A semiconductor manufacturing apparatus according to claim 9, wherein the X-rays or UV-rays have an energy in a range from 4 eV or more and 10 keV or less.

15. A semiconductor manufacturing apparatus according to claim 9, wherein the X-rays have an energy in a range from 1 to 2 keV.

16. A semiconductor manufacturing apparatus according to claim 9, wherein the UV-rays have an energy in a range from 4 to 10 eV.

17. A semiconductor manufacturing apparatus, comprising:
a holding section for holding a semiconductor substrate; and
an irradiation section for irradiation of at least one of X-rays and UV-rays;
wherein the inside of the holding section and the inside of the irradiation section are kept in a vacuum or in an inert gas atmosphere; and
wherein a semiconductor substrate after etching of a work formed on the semiconductor substrate or after deposition of a metal film or an insulating film on the semiconductor substrate, by use of plasma, is held in the holding section and the semiconductor substrate is irradiated with at least one of X-rays and UV-rays from the irradiation section.

18. A semiconductor manufacturing apparatus according to claim 17, wherein the X-rays have an energy in a range from 1 to 2 keV.

19. A semiconductor manufacturing apparatus according to claim 17, wherein the UV-rays have an energy in a range from 4 to 10 eV.
